(19) United States
(12) Patent Application Publication
(10) Pub. No.: US 2008/0213484 A1
(43) Pub. Date: Sep. 4, 2008

(54) Method for producing top coating film and clear coating composition

(76) Inventors: Daisuke Segawa, Osaka (JP); Katsuhiko Sugimoto, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 11/984,756

(22) Filed: Nov. 21, 2007

(30) Foreign Application Priority Data
Nov. 21, 2006 (JP) 2006-313957

(51) Int. Cl. B05D 3/02; C08L 33/06

(52) U.S. Cl. 427/379; 525/229

(57) ABSTRACT

A first clear coating composition comprising (a) an acryl resin having a hydroxyl value of 110 to 160 mgKOH/g and an acid value of 5 to 35 mgKOH/g, (b) an acryl resin having a hydroxyl value of 10 to 150 mgKOH/g and an epoxy equivalent of 230 to 800 g/eq, and (c) a curing agent of a melamine resin, which has a solubility parameter (SP value) within a range of from 9.5 to 11.0, and which comprises no less than 50% by weight of an imino group-containing melamine resin. The composition is effective in a three coating and two baking (3C2B) coating process which includes applying a base coating composition, applying a first clear coating composition thereon by a wet-on-wet procedure, curing the coatings, applying a second clear coating composition thereon, and then curing the coating.

### TECHNICAL FIELD

The present invention relates to a method for producing a coating film, especially relates to a method for producing a top coating film, which includes applying a base coating composition, such as a metallic color base coating composition and a solid color base coating composition, to form a base coating; applying a first clear coating composition on the base coating to form a first clear coating; curing the base coating and the first clear coating to form a base coating film and a first clear coating film; applying a second clear coating composition thereon to form a second clear coating; and curing the second clear coating to form a second clear coating film.

### BACKGROUND OF THE INVENTION

With respect to a coating on an article such as a vehicle body, wherein the coating is a multi layered coating film formed with some coating compositions, the coating appearance is one of the most important factors. The article is generally subjected to an under coating process and an intermediate coating process, and then a top coating process. For example, the top coating process for a vehicle body includes applying a base coating composition to form a base coating to be a colored coating film; applying a clear coating composition (i.e., first clear coating composition) on the uncured base coating, by a wet-on-wet procedure; and then curing these two coatings to form a top coating film. In order to obtain a much superior coating appearance, a clear coating composition (i.e., second clear coating composition) may be further applied thereon. In this case, a three coating and two baking (3C2B) coating process is widely applicable, wherein the 3C2B coating process includes applying a base coating composition, on an article, to form a base coating; applying a first clear coating composition, on the base coating, to form a first clear coating; curing the base coating and the first clear coating at once; applying a second clear coating composition thereon to form a second clear coating; and then curing the second clear coating to form a multi layered coating film.

If a high performance clear coating composition is employed as a second clear coating composition, the first clear coating film often contains a resin having a high polarity as a resin component in consideration of wettability (i.e., draping) to the resulting second clear coating film, in order to maintain the adhesion between the first clear coating film and the second clear coating film without grinding the surface of the first clear coating film. In this case, upon/after the wet-on wet coating procedure, the previously formed base coating and the first clear coating may be mixed on the coating boundary. If the base coating includes a mica pigment and/or a luster color pigment such as aluminum, there may be a disturbance of the orientation of the luster color pigment in the previously formed base coating, which would results in a decrease in a flip-flop property of the resulting multi layered coating film, which may be simply abbreviated as F-F property.

JP-A-11-207255 (corresponding to WO 99/37410) (Patent Literature 1) discloses a first clear coating composition which is an organic solvent type coating composition comprising an acryl resin having a hydroxyl group-containing long-chain group and a hydroxyl group containing short-chain group; a polyepoxide; and melamine curing agent, which is employed in the 3C2B coating process. The acryl resin having a hydroxyl group-containing long-chain group and a hydroxyl group containing short-chain group seems to improve the adhesion to a later-formed second clear coating film. Sufficient flip-flop property is not always obtained. The interlayer adhesion after a water resistance test and the interlayer adhesion after a thermal cycle test, wherein the interlayer adhesion is tested in the cold regions, are sometimes insufficient due to the insufficiency in the flexibility of the coating film.

JP-A-2000-136345 (Patent Literature 2) discloses a method for producing a thin-layered coating film, wherein a first clear coating composition comprising a hydroxyl group-containing resin, a melamine resin and an epoxy group-containing compound is employed, in a 3C2B coating process. The first clear coating composition has a good adhesion to a later-formed second clear coating film as well. The resulting coating film does not always have a good flip-flop property.

JP-A-2003-277678 (Patent Literature 3) discloses a coating composition, as a first clear coating composition, which comprises an acryl resin, a polyester oligomer, an iminomethylol type butylated melamine resin and an iminomethylol type methylated melamine resin, and which is employed in a 3C2B coating process. The disclosed composition can provide a multi layered coating film having a high adhesion and a good appearance. Improvement of the flip-flop property is not significantly suggested in the literature. The other properties such as an interlayer adhesion after a thermal cycle test, wherein the interlayer adhesion is tested in the cold regions, are not investigated.

JP-A-2001-54760 (Patent Literature 4) discloses a first clear coating composition and a second clear coating composition, wherein solubility parameters of the resin compositions are defined to improve the interlayer adhesion. The literature does not suggest how to use a curing agent. The conditions of the resulted base coating film, especially flip-flop property, are insufficient.

### REFERENCES

Patent Literature 1: JP-A-11-207255 (corresponding to WO 99/37410)
Patent Literature 2: JP-A-2000-136345
Patent Literature 3: JP-A-2003-277678
Patent Literature 4: JP-A-2001-54760

### SUMMARY OF THE INVENTION

### Disclosure of Invention

### Problem to be Solved by the Invention

Object of the present invention consists in a provision of an improved first clear coating composition which is employed in a so-called 3C2B coating process comprising steps of applying a base coating composition, on an article, to form a base coating; applying a first clear coating composition, on the base coating, by a wet-on-wet procedure, to form a first clear coating; heating and/or curing the base coating and the first clear coating to form a (cured) base coating film and a (cured) first clear coating film; applying a second clear coating composition thereon to form a second clear coating; and then heating and/or curing the second clear coating to form a (cured) second clear coating film. The improvement of the first clear coating composition can prevent disturbing an orientation of luster color pigment(s) in the base coating film and maintain F-F property at a high level. Other object of the present invention consists in a provision of a 3C2B coating process to form a multi layered film comprising a base coating film, a first clear coating film and a second clear coating film, wherein the interlayer adhesion between the base coating film and the first clear coating film, and the interlayer adhesion between the first clear coating film and the second clear coating film can be maintained at a high level without any grinding on the underlying layer(s). The additional object of the present invention consists in improvements of the interlayer adhesions after a thermal cycle test.

### Means for Solving Problem

The present invention provides a method for producing a top coating film comprising a base coating film, a first clear coating film and a second clear coating film, which includes steps of:

applying a base coating composition on an article to form a base coating;

applying a first clear coating composition on the base coating to form a first clear coating;

curing (or baking) the base coating and the first clear coating at once to form a (cured) base coating film and a (cured) first clear coating film;

applying a second clear coating composition thereon to form a second clear coating; and

curing (or baking) the second clear coating to form a second clear coating film,

wherein the first clear coating composition comprises

(a) an acryl resin having a hydroxyl value of 110 to 160 mgKOH/g and an acid value of 5 to 35 mgKOH/g, which is obtainable by a polymerization of (1) an acryl monomer having an alkyl ester group having at least 8 carbon atoms, (2) an acryl monomer having a hydroxyl group wherein at least 4 carbon atoms are placed between the hydroxyl group and the acryl group therein, (3) an acryl monomer having a carboxyl group, and (4) other acryl monomer, wherein content of the acryl monomer (1) having an alkyl ester group having at least 8 carbon atoms is 5 to 20% by weight relative to total monomer weight;

(b) an acryl resin having a hydroxyl value of 10 to 150 mgKOH/g and an epoxy equivalent of 230 to 800 g/eq, which is obtainable by a polymerization of (5) an acryl monomer having a hydroxyl group, (6) an acryl monomer having an epoxy group, and (7) other acryl monomer; and

(c) a curing agent of a melamine resin, which has a solubility parameter (SP value) within a range of from 9.5 to 11.0, and which comprises no less than 50% by weight of an imino group-containing melamine resin, and

wherein the second clear coating composition is a clear coating composition comprising a polyepoxide and a polyacid, or an urethane clear coating composition comprising a hydroxyl group-containing resin and a polyisocyanate curing agent.

### Effect of the Invention

According to the present invention, the first clear coating composition comprises coating resin components, one of which is an acryl resin (a), which is obtainable by a polymerization of acryl monomers, one of which is an acryl monomer having an alkyl ester group having at least 8 carbon atoms as a polymerization monomer. The first clear coating composition can provide an improved hydrophobicity for the resulting first clear coating composition. Therefore, the hydrophobicity prevents the fist coating composition from penetrating into a base coating composition containing a luster color pigment(s). The prevention can maintain flip-flop property at a high level. Generally, a cured clear coating film is subjected to an application with a further (i.e., second) clear coating composition. In this case, the interlayer adhesion between the first clear coating and the second clear coating is deteriorated. Under such circumstances, according to the present invention, the first clear coating composition further comprises an acryl resin (b) having a hydroxyl group and an epoxy group; and an imino group-containing melamine resin (c), wherein the content of the imino group-containing melamine resin (c) is no less than 50% by weight relative to the total weight of the melamine resin. The first clear coating composition can improve the reactivity to the second clear coating composition, and therefore improve the interlayer adhesion between the resulting first and second clear coating films.

### DETAILED DESCRIPTION OF THE INVENTION

### Detailed Description of the Preferred Embodiments

A method for producing a top coating film according to the present invention is further described in detail as follows.

### Base Coating Composition

A base coating composition can be applied on an article to be coated according to the present method. The base coating composition includes a known thermosetting coating composition comprising a resin component, a coloring pigment, and a solvent, such as a solid color coating composition, a metallic color coating composition, a pearl tone color coating composition, etc. If the base coating composition is used in a combination with the first clear coating composition according to the present invention, a base coating composition preferably comprises a luster color pigment(s), which desirably has a good compatibility to the first clear coating composition, in order to provide an excellent F-F property.

Specifically, the resin component can be prepared from at least one base resin selected from a group consisting of the conventional resins such as an acryl resin, a vinyl resin, a polyester resin, an alkyd resin and an urethane resin, each of which has a crosslinkable functional group (e.g., a hydroxyl group, an epoxy group, a carboxyl group, an alkoxysilane group, and the like) and at least one crosslinking agent to crosslink and/or cure the above-listed resin, which is selected from the group consisting of the conventional agents such as an alkyletherized melamine resin, an urea resin, a guanamine resin, a (blocked) polyisocyanate compound, an epoxy compound and carboxyl group-containing compound. A preferable combination is a combination of 50 to 90% by weight of the base resin and 50 to 10% by weight of the crosslinking agent relative to the total weight of the base resin and the crosslinking agent.

The coloring pigment includes pigments for solid colors, metallic colors and pearl tone colors, such as inorganic pigments such as titanium oxide, Zinc white, cadmium red, molybdenum red, chromium yellow, chromium oxide, Prussian blue, cobalt blue; organic pigments such as azo pigments, phthalocyanine pigments, quinacridone pigments, benzimidazolone pigments, diketopyrrolopyrrole pigments, isoindolinone pigments, durene pigments, perylene pigments; metallic pigments such as aluminum flakes; mica; metal oxide-surface coated mica; mica-like iron oxide; carbon black; etc. A single coloring pigment may be used alone or at least two coloring agents may be used in a combination.

The solvent includes organic solvents. The organic solvent includes conventional organic solvents suitable for a coating composition.

The base coating composition may be a waterborne coating composition, which includes water as a principle solvent. An organic solvent may be added to the waterborne coating composition.

If necessary, the base coating composition may further comprise a conventional additive for a coating composition, such as filler pigments, ultraviolet (UV) absorbers, photostabilizers, rheology control agents, anti-cissing agents, etc.

According to the present invention, the base coating composition can be directly applied to an article to be coated. The article includes metals or plastics. The article is preferably a vehicle body. An under coating composition such as a cationic electrodeposition coating composition may be applied on the article, and then, if necessary, an intermediate coating composition may be applied thereon. The base coating composition can applied on the cured cationic electrodeposition coating or the cured intermediate coating.

The base coating composition can be applied by a means such as an air spraying equipment, an electrostatic coating equipment, etc. Application of the base coating composition is preferable such that thickness of the cured coating film is within a range of from about 10 to about 50 μm. If necessary, an interval for some minutes may be placed at from room temperature to about 100° C. A first clear coating composition, which is further described below, can be applied on the uncured base coating.

### First Clear Coating Composition

According to the present invention, the first clear coating composition to be applied on the uncured base coating of the base coating composition can form a transparent coating film.

The first clear coating composition comprises

(a) an acryl resin having a hydroxyl value of 110 to 160 mgKOH/g and an acid value of 5 to 35 mgKOH/g, which is obtainable by a polymerization of (1) an acryl monomer having an alkyl ester group having at least 8 carbon atoms, (2) an acryl monomer having a hydroxyl group wherein at least 4 carbon atoms are placed between the hydroxyl group and the acryl group therein, (3) an acryl monomer having a carboxyl group, and (4) other acryl monomer, wherein content of the acryl monomer (1) having an alkyl ester group having at least 8 carbon atoms is 5 to 20% by weight relative to total monomer weight;

(b) an acryl resin having a hydroxyl value of 10 to 150 mgKOH/g and an epoxy equivalent of 230 to 800 g/eq, which is obtainable by a polymerization of (5) an acryl monomer having a hydroxyl group, (6) an acryl monomer having an epoxy group, and (7) other acryl monomer; and

(c) a curing agent of a melamine resin, which has a solubility parameter (SP value) within a range of from 9.5 to 11.0, and which comprises no less than 50% by weight of an imino group-containing melamine resin. The first clear coating composition may be an organic solvent type coating composition.

As described above, the acryl resin (a) is obtainable by a polymerization of (1) an acryl monomer having an alkyl ester group having at least 8 carbon atoms, (2) an acryl monomer having a hydroxyl group wherein at least 4 carbon atoms are placed between the hydroxyl group and the acryl group therein, (3) an acryl monomer having a carboxyl group, and (4) other acryl monomer. Content of the acryl monomer (1) for the acryl resin (a), which has an alkyl ester group having at least 8 carbon atoms, is 5 to 20% by weight, and preferably 15 to 13% by weight, relative to total weight of the acryl monomers for the acryl resin (a). If the content is lower than 5% by weight, it may be difficult to ensure the flip-flop property of the resulting coating film. If the content is more than 20% by weight, the interlayer adhesion may be decreased.

The acryl monomer (1) has an alkyl ester group having at least 8, preferably 8 to 18, and more preferably 10 to 15 carbon atoms. The acryl monomer (1) can prevent the first clear coating from draping onto the base coating upon a wet-on-wet coating procedure. The acryl monomer (1) can improve flip-flop property of the resulting base coating film. The acryl monomer (1) can suppress a generation of the internal curing stress in the first clear coating film. Therefore, curing stress in the second clear coating film thereon can be preferably suppressed. Examples of the monomer (1) include 2-ethylhexyl (meth)acrylate, octyl (meth)acrylate, decyl (meth)acrylate, dodecyl (meth)acrylate, lauryl (meth)acrylate, stearyl (meth)acrylate, t-butylcyclohexyl (meth)acrylate, dicyclopentadienyl (meth)acrylate, and a mixture thereof. The alkyl ester group having at least 8 carbon atoms can preferably prevent the first clear coating composition from penetrating into the base coating composition. If the alkyl ester group has more than 18 carbon atoms, there may be a deteriorated interlayer adhesion between the first clear coating film and the second clear coating film, which is undesired.

Among others, the preferable acryl monomer (1) has a long and/or straight alkyl ester group at least 8 carbon atoms, such as lauryl (meth)acrylate, decyl (meth)acrylate, dodecyl (meth)acrylate, etc. A single acryl monomer may be used alone or two or more acryl monomers may be used in a combination as an acryl monomer.

According to the present invention, the acryl monomer (2) for the acryl resin (a) essentially has a hydroxyl group, wherein at least 4, preferably 4 to 16, and more preferably 4 to 9 carbon atoms are placed between the hydroxyl group and the acryl group therein. With respect to the wording “between the hydroxyl group and the acryl group therein (i.e., in the acryl monomer (2))”, as used herein, the distance “between the hydroxyl group and the acryl group” is represented by the number of the carbon atoms between them. Herein, the acryl group in the acryl monomer (2) is represented by the following formula:

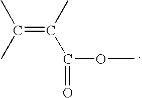

The number of the carbon atoms is counted from the carbon atom attached to the oxygen atom in the acrylate (i.e., —O— in the above-represented formula) to the carbon atom attached to the hydroxyl group in the acryl monomer (2), with the proviso that the number of the carbon atoms to be counted is the number of the carbon atoms in the straight chain between them, wherein the number of the carbon atom(s) in the branched chain is excluded. If an ether and/or ester structure(s) is/are inserted between the hydroxyl group and the acryl group, the number of the other atoms than the carbon atoms, such as oxygen atom(s), is excluded. Therefore, the “acryl monomer (2) having a hydroxyl group wherein at least 4 carbon atoms are placed between the hydroxyl group and the acryl group therein”, as used herein, means an acryl monomer having at least 4 carbon atoms between the hydroxyl group and the acryl group therein (i.e., oxygen atom (—O—) in the above acrylate moiety). The above-defined distance between the hydroxyl group and the acryl group has an advantage, since the distance can contribute to the reaction, without any adverse effects due to the steric hindrance. The acryl monomer having a hydroxyl group, wherein less than 4 carbon atoms are placed between the hydroxyl group and the acryl group therein, may be used as a monomer for the acryl resin (a), which is encompassed in the other acryl monomer (4). Examples of the acryl monomer (2) having a hydroxyl group wherein at least 4 carbon atoms are placed between the hydroxyl group and the acryl group therein include, for example, 4-hydroxybutyl (meth)acrylate, 5-hydroxypentyl (meth)acrylate, 6-hydroxyhexyl (meth)acrylate, 7-hdroxyheptyl (meth)acrylate, 8-hydroxyoctyl (meth)acrylate, 7-methyl-8-hydroxyoctyl (meth)acrylate, 2-methyl-8-hydroxyoctyl (meth)acrylate, a lactone-modified acryl monomer which is a reaction product of 1 mol of hydroxyethyl (meth)acrylate with 1 to 5 mol of a lactone such as ε-caprolactone, etc. The caprolactone-modified acryl monomer is commercially available, which includes, for example, Placcel FA-1, Placcel FA-2 and Placcel FA-3 (a monomer which is a addition product of 1, 2 or 3 mol of ε-caprolactone to 1 mol of hydroxyethyl acrylate) commercially available from DAICEL CHEMICAL INDUSTRIES, LTD., under the product names; Placcel FM-1, Placcel FM-2, Placcel FM-3 (a monomer which is a addition product of 1, 2 or 3 mol of ε-caprolactone to 1 mol of hydroxyethyl methacrylate) commercially available from DAICEL CHEMICAL INDUSTRIES, LTD., under the product names; TONE m-100 (a monomer which is an addition product of 2 mol of ε-caprolactone to 1 mol of hydroxyethyl acrylate) commercially available from The Dow Chemical Company (U.S.A.), under the product name, etc.

Examples of the acryl monomer (2) include a monoester of polyether glycol and (meth)acrylic acid; monoether of polyether glycol and hydroxyalkyl (meth)acrylate, such as “BLEMMER AP-150” commercially available from NOF CORPORATION, etc.

Among others, the preferable acryl monomer (2) (as acryl monomer (8)) includes 4-hydroxybutyl (meth)acrylate; Placcel FM-1, FM-2, FA-1 and FA-2 (each of which is a reaction product of hydroxyethyl (meth)acrylate and ε-caprolactone); each of which has a hydroxyl group wherein at least 4 carbon atoms are placed between the hydroxyl group and the acryl group therein. A single preferable monomer may be used alone or two or more preferable monomers may be used in a combination as an acryl monomer.

Particularly preferable amount of the acryl monomer (2) having a hydroxyl group wherein at least 4 carbon atoms are placed between the hydroxyl group and the acryl group therein is no less than 50% by weight relative to the total of the weight of the monomers having a hydroxyl group, which are required for preparing the acryl resin (a) (i.e., total of the weight of the other acryl monomer (4) having a hydroxyl group, and the weight of the acryl monomer (2) having a hydroxyl group wherein at least 4 carbon atoms are placed between the hydroxyl group and the acryl group therein). If the amount of the acryl monomer (2) having a hydroxyl group wherein at least 4 carbon atoms are placed between the hydroxyl group and the acryl group therein is less than 50% by weight relative to the total weight of the monomers having a hydroxyl group, the reactivity of the second clear coating composition to the cured first clear coating film may be insufficient. Therefore, the interlayer adhesion between the first clear coating film and the second clear coating film may be decreased. The most preferable amount is within a range of from 55 to 100% by weight.

The acryl monomer having a carboxyl group (3) includes acrylic acid, methacrylic acid, dimeric acrylic acid, crotonic acid, 2-acryloyloxyethyl phthalic acid, 2-acryloyloxyethylsuccinic acid, isocrotonic acid, maleic acid, fumaric acid, itaconic acid, 3-vinylsalicylic acid, 3-vinyl-acetylsalicylic acid, 2-acrylamide-2-methylpropane-sulfonic acid, etc. Among others, acrylic acid and methacrylic acid are preferable.

The other acryl monomer (4) includes acryl monomers other than the following acryl monomers (1), (2) and (3):

(1) an acryl monomer having an alkyl ester group having at least 8 carbon atoms,

(2) an acryl monomer having a hydroxyl group wherein at least 4 carbon atoms are placed between the hydroxyl group and the acryl group therein, and

(3) an acryl monomer having a carboxyl group. The other acryl monomer (4) is copolymerizable with the acryl monomer(s) (1), (2) and/or (3).

The other acryl monomer (4) includes
(meth)acrylates wherein the ester moiety has no more than 7 carbon atoms (e.g., methyl (meth)acrylate, ethyl (meth)acrylate, propyl (meth)acrylate, n-butyl (meth)acrylate, isobutyl (meth)acrylate, t-butyl (meth)acrylate, hexyl (meth)acrylate, phenyl (meth)acrylate, cyclohexyl (meth)acrylate, etc.);
hydroxyl group-containing acryl monomers other than the acryl monomer (2) having a hydroxyl group wherein at least 4 carbon atoms are placed between the hydroxyl group and the acryl group therein (e.g., 2-hydroxyethyl (meth)acrylate, hydroxypropyl (meth)acrylate, 2-hydroxybutyl (meth)acrylate, etc.);
polymerizable amide compounds (e.g., (meth)acrylamide, N-methylol (meth)acrylamide, N-butoxymethyl (meth)acrylamide, N,N-dimethyl (meth)acrylamide, N,N-dibutyl (meth)acrylamide, N,N-dioctyl (meth)acrylamide, N-monobutyl (meth)acrylamide, N-(2-hydroxyethyl)(meth)acrylamide, etc.);
polymerizable aromatic compounds (e.g., styrene, α-methylstyrene, vinyl ketone, t-butylstyrene, para-chlorostyrene and vinyl naphthalene, etc.);
polymerizable nitriles (e.g., acrylonitrile, methacrylonitrile, etc.);
vinyl esters (e.g., vinyl acetate, vinyl propionate, etc.);
dienes (e.g., butadiene, isoprene, etc.);
polymerizable aromatic compounds;
polymerizable nitriles;
α-olefines;
vinyl esters; and
dienes, etc.
The other acryl monomer (4) can be appropriately selected depending on the purpose.

It is preferable that the content of the other acryl monomer (4) is less than 35% by weight relative to total monomer weight, i.e., total weight of the monomer mixture.

The acryl resin (a) can be prepared by a conventional method, for example, wherein the above-described monomers are subjected to a solution polymerization in the presence of a catalyst for a radical polymerization.

The content of the monomer can be determined such that the resulting acryl resin has a hydroxyl value within a range of from 110 to 160 mgKOH/g, and preferably from 120 to 150 mgKOH/g. If the hydroxyl value is less than 110 mgKOH/g, the resulting coating film may have an unensured curability. If the hydroxyl value is more than 160 mgKOH/g, the coating film may have a decreased water resistance. The acryl resin (a) has an acid value of 5 to 35 mgKOH/g, and preferably 10 to 30 mgKOH/g. If the acid value is more than 35 mgKOH/g, the crosslinking reaction can extremely proceed, the resulting coating film may have an unensured is flexibility, and the resulting coating film may have a decreased water resistance. If the acid value is less than 5 mgKOH/g, the resulting coating film may have a decreased curability.

The acryl resin (a) preferably has a number average molecular weight within a range of from 2000 to 15000. If the number average molecular weight is less than 2000, the resulting coating film may have an insufficient hardness. If the number average molecular weight is more than 15000, the coating film may have a deteriorated appearance. The acryl resin (a) has a particular preferable number average molecular weight of 2500 to 5000.
Herein, the number average molecular weight can be determined by a gel permeation chromatography (GPC), wherein the number average molecular weight is calculated from the found measurement value based on the polystyrene standard.

The acryl resin (b) is obtainable by a polymerization of (5) an acryl monomer having a hydroxyl group, (6) an acryl monomer having an epoxy group, and (7) other acryl monomer. An additional monomer for the synthesis of the acryl resin (b), other than the above-described monomers (5) to (7), may be employed with the proviso that the additional monomer does not adversely effect on the resulting acryl resin (b). The acryl monomer (5), which has a hydroxyl group, encompasses

the above-described acryl monomer (2), which has a hydroxyl group, wherein at least 4 carbon atoms are placed between the hydroxyl group and the acryl group therein, and

Other acryl monomer, which has a hydroxyl group, wherein less than 4 carbon atoms are placed between the hydroxyl group and the acryl group therein.

Examples of the acryl monomer (5) include those exemplified in the above-described acryl monomer (2), which has a hydroxyl group, wherein at least 4 carbon atoms are placed between the hydroxyl group and the acryl group therein, and the other acryl monomer having a hydroxyl group, such as 2-hydroxyethyl (meth)acrylate, hydroxypropyl (meth)acrylate, 2-hydroxybutyl (meth)acrylate, etc. More preferable acryl monomer (5), which has a hydroxyl group, includes Placcel FM-1, FM-2, FA-1 and FA-2, each of which is a reaction product of 4-hydroxybutyl (meth)acrylate or hydroxy ethyl (meth)acrylate with ε-caprolactone, which is referred to as a hydroxyl group-containing monomer (8). Content of the hydroxyl group-containing monomer (8) is preferably no less than 50% by weight relative to the total weight of the acryl monomer (5) which has a hydroxyl group. If the content is less than 50% by weight, the reactivity of the second clear coating composition to the cured first clear coating film may be insufficient. As a result, the interlayer adhesion between the first clear coating film and the second clear coating film may be deteriorated.

The acryl monomer (6), which has an epoxy group, includes, but is not particularly limited to, an acryl monomer having an epoxy group and a polymerizable unsaturated double bond in the molecule, such as glycidyl (meth)acrylate, β-methylglycidyl (meth)acrylate, glycidyl ether of 4-hydroxybutyl (meth)acrylate, (meth)acrylate of 3,4-epoxycyclohexanemethanol, etc. The preferable acryl monomer (6) is glycidyl (meth)acrylate or glycidyl ether of 4-hydroxybutyl (meth)acrylate from the aspect of the reactivity.

The other acryl monomer (7) for the acryl resin (b) includes acryl monomers other than the following acryl monomers (5) and (6):

(5) the acryl monomer having a hydroxyl group, and

(6) the acryl monomer having an epoxy group.

The other acryl monomer (7) is copolymerizable with the acryl monomer(s) (5) and/or (6). The other acryl monomer (7) includes, for example,
(meth)acrylates (e.g., methyl (meth)acrylate, ethyl (meth)acrylate, propyl (meth)acrylate, n-butyl (meth)acrylate, isobutyl (meth)acrylate, t-butyl (meth)acrylate, hexyl (meth)acrylate, 2-ethylhexyl (meth)acrylate, octyl (meth)acrylate, decyl (meth)acrylate, lauryl (meth)acrylate, stearyl (meth)acrylate, isoboronyl (meth)acrylate, phenyl (meth)acrylate, cyclohexyl (meth)acrylate, etc.);
polymerizable amide compounds (e.g., (meth)acrylamide, N-methylol (meth)acrylamide, N-butoxymethyl (meth)acrylamide, N,N-dimethyl (meth)acrylamide, N,N-dibutyl (meth)acrylamide, N,N-dioctyl (meth)acrylamide, N-monobutyl (meth)acrylamide, N-(2-hydroxyethyl) (meth)acrylamide, etc.);
polymerizable aromatic compounds (e.g., styrene, α-methylstyrene, vinyl ketone, t-butylstyrene, para-chlorostyrene and vinyl naphthalene, etc.);
polymerizable nitrites (e.g., acrylonitrile, methacrylonitrile, etc.);
vinyl esters (e.g., vinyl acetate, vinyl propionate, etc.);
dienes (e.g., butadiene, isoprene, etc.);
polymerizable aromatic compounds;
polymerizable nitrites;
α-olefines;
vinyl esters;
dienes; etc.
The other acryl monomer (7) can be appropriately selected depending on the purpose.

It is preferable that the content of the other acryl monomer (7) is less than 35% by weight relative to the total monomer weight, i.e., total weight of the monomer mixture.

It is preferable that the acryl resin (b) has a hydroxyl value of 10 to 150 mgKOH/g, and more preferably 20 to 130 mgKOH/g, an epoxy equivalent of 230 to 800 g/eq, and more preferably 250 to 700 g/eq, and a preferable number average molecular weight of about 1500 to 12000, and more preferably 2000 to 4000. If the hydroxyl value is less than 10 mgKOH/g, the adhesion of the resulting coating film may be decreased. If the hydroxy value is more than 150 mgKOH/g, the water resistance and/or flip-flop property of the resulting coating film may be deteriorated. Therefore, these circumstances are not desirable. If the epoxy equivalent is less than 230 g/eq, water resistance of the resulting multi layered coating film including the second clear coating film may be decreased. If the epoxy equivalent is more than 800 g/eq, the adhesion of the resulting coating film may be deteriorated. If the number average molecular weight is less than 1500, the resulting coating film may have an insufficient hardness. If the number average molecular weight is more than 12000, the resulting coating film may have a deteriorated appearance.

### Curing Agent of Melamine Resin (c)

The curing agent of a melamine resin has a solubility parameter (SP value) within a range of from 9.5 to 11.0, and comprises no less than 50% by weight of an imino group-containing melamine resin.

The imino group-containing melamine resin (c) has a partial structure, i.e., melamine structure, as described below:

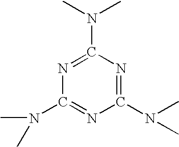

wherein it is preferable that at least one nitrogen atom forms an imino group (i.e., —NH— or ═NH).

The nitrogen (N) atoms attached to the triazine moiety in the above melamine structure may have 6 substituents. The imino group-containing melamine resin, which is also referred to as an imino-type melamine resin, preferably has at least one imino groups formed with the nitrogen atoms. The nitrogen atom(s) other than the imino group may have other substituent(s) such as a C₁-C₃₀ alkoxy group, an alkoxymethyl group (i.e., —N(CH₂OR)— wherein R is a C₁-C₃₀ alkyl group) and a methylol group (i.e., —N(CH₂OH)—)).

The first clear coating composition comprises the melamine resin, wherein the content of the imino group-containing melamine resin is essentially no less than 50% by weight. If the content is less than 50% by weight, the interlayer first adhesion in the resulting multi layered coating film may be decreased. It is preferable that the content of the imino group-containing melamine resin is within a range of form 50 to 75% by weight relative to total weight of the melamine resin. As stated above, the imino group-containing melamine resin has at least one imino group in the repeating unit (in average). If the imino group-containing melamine resin contains less than one imino group in the repeating unit (in average), the curability and adhesion of the resulting coating film may be reduced. If the imino group-containing melamine resin contains unnecessary imino groups, e.g., no less than 3.5 imino groups in the repeating unit (in average), the resulting coating film may have a hardness and a brittleness, and therefore the coating film may have poor water resistance and poor impact resistance, which is not preferable.

Examples of the melamine resin having at least one imino group include U-VAN-125 (commercially available from Mitsui Chemicals, Inc., under a product name), U-VAN-225 (commercially available from Mitsui Chemicals, Inc., under a product name), Cymel 254 (commercially available from Mitsui Cytec Industries Inc., under a product name), Mycoat 508 (commercially available from Mitsui Cytec Industries Inc., under a product name), etc.

The melamine resin has a solubility parameter (SP value) within a range of from 9.5 to 11.0, and preferably from 9.7 to 10.9. If the SP value is more than 11.0, the adhesion of the resulting coating film to the second clear coating composition may be decreased, and the water resistance of the resulting coating film may be decreased. If the SP value is less than 9.5, the transparency of the resulting coating film may be decreased. Therefore, these circumstances are not desirable. The imino group-containing melamine resin has an individual SP value. The SP value is the abbreviation of solubility parameter, and therefore SP value is an index of a solubility. It is indicated that SP value is larger, the polarity is higher, whereas, SP value is smaller, the polarity is lower.

The imino group-containing melamine resin has a possibility for the self-condensation. It is considered that the interlayer adhesion between the first clear coating film and the second clear coating film can be improved due to the increased number of the residual unreacted hydroxyl groups in the first clear coating film. If the content of the imino group-containing melamine resin is more than 75% by weight relative to the total weight of the melamine resin, the self-condensation may excessively proceed, and therefore the resulting coating film may loose the flexibility and the water resistance of the resulting coating film may be decreased. If the content of the imino group-containing melamine resin is less than 50% by weight, it may be difficult to exist the unreacted hydroxyl groups in the first clear coating film, and therefore the interlayer adhesion between the first clear coating film and the second clear coating film may be decreased. Therefore, these circumstances are not desirable.

Generally, measurements for resin SP value are known in the art, wherein a resin is dissolved in a good solvent having a given SP value to give a solution, the solution can be subjected to turbidimetric titration with a poor solvent having a given higher SP value than that of the good solvent, and/or with a poor solvent having a given lower SP value than that of the good solvent to determine a resin SP value (see Reference 1: C. M. Hansen, J. Paint. Tech., 39 [505], 104 (1967) and Reference 2: “Color materials (SHIKIZAI)” by Toshikatsu Kobayashi, 77 [4], 188-192 (2004)).

For example, a resin SP value can be determined according to the following conditions.

Measuring temperature: 20° C.

Sample: 0.5 g of a resin is weighed in a 100 ml beaker, 10 ml of a good solvent is added to the beaker with a whole pipette, and then the resin is dissolved in the solvent with a magnetic stirrer.

Good solvent: Acetone (SP value (δg) (measured by a Hansen method): 9.77)

Poor solvent: Hexane (SP value (δpl): 7.24 (i.e., a lower SP value)) or deionized water (SP value (δph): 23.50 (i.e., a higher SP value))

Turbidimetric titration: Poor solvent is added dropwise to the sample with a 50 ml burette, and then at a point at which turbidity is generated, the titration amount is recorded.

φpl: volume proportion of hexane

φph: volume proportion of deionized water

The SP values (δml and δmh, wherein SP value (δml) is a volume of the added hexane at a point turbidity is generated by the addition of hexane (i.e., SP value of the hexane containing mixture) and SP value (δmh) is a volume of the added deionized water at a point turbidity is generated by the addition of deionized water (i.e., SP value of the deionized water containing mixture)) can be independently represented by an average (in volume) of SP values of the good solvent and the poor solvent.

δml=φplδpl+(1−φpl)δg (Equation I)

δmh=φphδph+(1−φph)δg (Equation II)

The resin SP value (δpoly) is an average of the SP values (δml and δmh), which is determined by the following equation:

δpoly=(δml+δmh)/2 (Equation III)

The content of the acryl resin (a) is preferably within a range of from 50 to 85% by weight, and particularly preferably from 60 to 80% by weight relative to the weight of the resin solid component in the coating composition. If the content is more than 85% by weight, the adhesion to the coating film thereon may be decreased. If the content is less than 50% by weight, the anti-miscibility to the base coating film may be decreased.

The content of the acryl resin (b) is preferably within a range of from 5 to 30% by weight, and particularly preferably from 8 to 25% by weight relative to the weight of the resin solid component in the coating composition. If the content is more than 30% by weight, the resulting coating film may have an excessive hardness and be brittle. If the content is less than 5% by weight, the adhesion to the coating film thereon may be decreased.

The content of the melamine resin (c) is preferably within a range of from 10 to 40% by weight, and particularly preferably from 15 to 35% by weight relative to the weight of the resin solid component in the coating composition. If the content is more than 40% by weight, the resulting coating film may have an excessive hardness and be brittle. If the content is less than 10% by weight, the curability of the coating composition may be decreased.

The first clear coating composition according to the present invention may further comprise, if necessary, a conventional additive(s) for a coating composition, such as curing catalysts, coloring pigments, filler pigments, ultraviolet (UV) absorbers, photostabilizers, rheology control agents, anti-cissing agents, etc. The non-colored transparent coating film without any coloring pigments, i.e., the clear coating film may be colored, such that the color tone of the base coating film can be visually observed through the colored coating film.

The first clear coating composition can be applied on the uncured base coating by a means, such as an air spraying and an electrostatic coating, and then subjected to a heating at 100 to 180° C., and preferably 120 to 160° C., for 10 to 40 minutes to provide a cured first clear coating film. The cured coating film has a thickness of 10 to 50 μm. A second clear coating composition, as described below in detail, can be applied on the cured first clear coating film.

The application of the first clear coating composition, which can form a colored clear coating film, on the base coating film (i.e., colored base film) can provide an improved designs and aesthetics superior to those of the single base coating film, which improvement can be arisen from the solid color tastes, the metallic color tastes and/or the pearl tone color tastes derived from these coating films, i.e., the synergistic effects.

### Second Clear Coating Composition

The second clear coating composition is a clear coating composition comprising a polyepoxide and a polyacid (i.e., a clear coating composition in an acid-epoxy curing system), or an urethane clear coating composition comprising a hydroxyl group-containing resin and a polyisocyanate curing agent.

The second clear coating composition is preferably a clear coating composition in an acid-epoxy curing system. Particularly preferably, the clear coating composition in an acid-epoxy curing system comprises (a) an acid anhydride group-containing acryl resin, (b) a carboxyl group-containing polyester resin, and (c) an acryl resin having a hydroxyl group and an epoxy group. The second clear coating composition comprising the components (a), (b) and (c) in high solid contents can provide a coating film having an excellent acid resistance. The acid anhydride group-containing acryl resin (a) is preferably half-esterified on the acid anhydride group therein with an alcohol component, such as an alcohol having a low molecular weight, from the aspect of the storage stability. The carboxyl group-containing polyester resin (b) may further have a hydroxyl group.

The acid anhydride group-containing acryl resin (a), the carboxyl group-containing polyester resin (b) and the acryl resin (c) having a hydroxyl group and an epoxy group can be combined in an appropriate amount known to those skilled in the art in accordance with a conventional method known to those skilled in the art.

It is preferable that the molar ratio of the carboxyl group(s) of the acid anhydride group-containing acryl resin (a) and the carboxyl group(s) of the carboxyl group-containing polyester resin (b) to the epoxy group(s) of the acryl resin (c) having a hydroxyl group and an epoxy group [the carboxyl group(s) in the components (a) and (b)/the epoxy group(s) in the component (c)] is within a range of from 1/1.4 to 1/0.6, and preferably from 1/1.2 to 1/0.8 and the molar ratio of the carboxyl group(s) of the acid anhydride group-containing acryl resin (a) to the hydroxyl group(s) of the carboxyl group-containing polyester resin (b) and the hydroxyl group(s) of the acryl resin (c) (having a hydroxyl group and an epoxy group) [the carboxyl group(s) in the component (a)/the hydroxyl group(s) in the components (b) and (c)] is within a range of from 1/2.0 to 1/0.5, and more preferably from 1/1.5 to 1/0.7.

If the molar ratio of the carboxyl group(s) in the components (a) and (b)/the epoxy group(s) in the component (c) is more than 1/0.6, the curability of the resulting coating composition may be decreased. If the molar ratio [the carboxyl group(s) in the components (a) and (b)/the epoxy group(s) in the component (c)] is less than 1/1.4, the resulting coating film may be yellowed. If the molar ratio of the carboxyl group(s) in the component (a)/the hydroxyl group(s) in the components (b) and (c)] is more than 1/0.5, the curability of the resulting coating composition may be decreased. If the molar ratio (the carboxyl group(s) in the component (a)/the hydroxyl group(s) in the components (b) and (c)) is less than 1/2.0, the excessive hydroxyl groups may reduce the water resistance. These contents can be determined in accordance with a calculation method well known to those skilled in the art with hydroxyl values, acid values and epoxy equivalents of the polymers.

According to the curing system of thus prepared second clear coating composition employed in the present invention, the heating of the acid anhydride group-containing acryl resin (a) allows the acid anhydride group in the resin (a) to react with the hydroxyl group in the carboxyl group-containing polyester resin (b) or the acryl resin (c) (having a hydroxyl group and an epoxy group). The reaction provides a crosslinking and generates a carboxyl group in the reaction product. The carboxyl group in the reaction product or the carboxyl group in the carboxyl group-containing polyester resin (b) can react with the epoxy group of the acryl resin (c) (having a hydroxyl group and an epoxy group) to form a crosslinking. As described above, the reaction between these three resins (i.e., polymers) can promote the curing in order to produce a high crosslinking density.

The urethane clear coating composition includes a clear coating composition comprising a hydroxyl group-containing resin and an isocyanate compound as a curing agent. The isocyanate compound, as a curing agent, includes, but is not particularly limited to, for example, aliphatic isocyanates such as trimethylene diisocyanate, tetramethylene diisocyanate, pentamethylene diisocyanate, hexamethylene diisocyanate (HDI), trimethylhexamethylene diisocyanate;

aliphatic-cyclic isocyanates such as 1,3-cyclopentane diisocyanate, 1,4-cyclohexane diisocyanate, 1,2-cyclohexane diisocyanate;
aromatic isocyanates such as xylylene diisocyanate (XDI), 2,4-tolylene diisocyanate (TDI), 2,6-tolylene diisocyanate;
alicyclic isocyanates such as isophorone diisocyanate (IPDI), norbornane diisocyanate methyl;
multimers thereof such as biurets and nulates; and
mixtures thereof, etc.

The hydroxyl group-containing resin has a hydroxyl value within a range of from preferably 20 to 200. If the hydroxyl value is more than 200, the resulting coating film may have a reduced water resistance. If the hydroxyl value is less than 20, the resulting coating film may have an inferior curability. The lower limit of the hydroxyl value is more preferably 30. The upper limit of the hydroxyl value is more preferably 180.

The hydroxyl group-containing resin has an number average molecular weight within a range of from preferably 1000 to 20000. If the number average molecular weight is less than 1000, the workability and curability may be insufficient. If the number average molecular weight is more than 20000, the non-volatile content upon coating is too low, therefore the workability may be inferior. The lower limit of the number average molecular weight is more preferably 2000. The upper limit of the number average molecular weight is more preferably 15000. Herein, the molecular weight can be determined by a GPC method wherein a styrene polymer is a standard.

The hydroxyl group-containing resin further has an acid value within a range of from preferably 2 to 30 mgKOH/g. If the acid value of the hydroxyl group-containing resin is more than 30 mgKOH/g, the resulting coating film may have an inferior water resistance. If the acid value of the hydroxyl group-containing resin is less than 2 mgKOH/g, the resulting coating film may have a decreased curability. The lower limit of the acid value is more preferably 3 mgKOH/g. The upper limit of the acid value is more preferably 25 mgKOH/g.

Proportion of the isocyanate compound to the hydroxyl group-containing resin can be appropriately determined depending on the application. In the clear coating composition employed according to the present invention, it is preferable that the proportion (as an equivalent ratio) of the isocyanate group (NCO) to the hydroxyl group (OH) is within a range of from 0.5 to 1.7 [NCO/OH]. If the proportion is less than 0.5, the curability may be insufficient. If the proportion is more than 1.7, the resulting coating film may have an excessive hardness and be brittle. The lower limit of the proportion is more preferably 0.7. The upper limit of the proportion is more preferably 1.5. The form of the clear coating composition may be in a solvent type or a waterborne type.

The hydroxyl group-containing resin includes, but is not particularly limited to, for example, acryl resins, polyester resins, alkyd resins, polyether resins, etc. One single resin may be used alone, or two or more resins may be used in a combination. Among others, the acryl resin and/or the polyester resin are/is preferable in an aspect of film performances such as weather resistance and water resistance.

The second clear coating composition may further comprise an ultraviolet (UV) absorbing agent, a hindered amine photostabilizer, an antioxidant or the like to improve a weather resistance of the resulting coating film. The second clear coating composition may further comprise a rheology control agent, such as crosslinked resin particles, and/or a surface conditioner to improve an appearance of the resulting coating film. If necessary, it is preferable that the second clear coating composition may further comprise a curing catalyst.

If the second clear coating composition comprises a crosslinked resin particle, the content of the crosslinked resin particle is within a range of from 0.01 to 10 parts by weight, and preferably 0.1 to 5 parts by weight, relative to 100 parts by weight of the solid resin contents in the second clear coating composition. If the content of the crosslinked resin particle is more than 10 parts by weight, the coating appearance may be deteriorated. If the content of the crosslinked resin particle is less than 0.01 part by weight, the rheology controlling effects may not be provided.

In the case that the resin in the coating composition employed in the present invention has an acid group as a functional group, the acid group can be neutralized with an amine to give a waterborne coating composition wherein water is a medium.

Specifically, the clear coating composition comprising a polyepoxide and a polyacid is preferably commercially available under a product name of “MACFLOW O-570 CLEAR” or “MACFLOW O-1820 CLEAR” from NIPPON PAINT Co., Ltd., from an aspect of an acid resistance. The urethane clear coating composition comprising a hydroxyl group-containing resin and a polyisocyanate curing agent is preferably commercially available under a product name of “R290S CLEAR” from Nippon Bee Chemical Co., Ltd.

A method for producing the first clear coating composition or the second clear coating composition includes, but is not particularly limited to, any methods well known to those skilled in the art.

The method for producing a top coating film, which is a multilayer, according to the present invention includes

applying the base coating composition on an article to form a base coating;

applying the first clear coating composition on the base coating to form a first clear coating;

heating (or baking) the base coating and the first clear coating at once to form a cured base coating film and a cured first clear coating film;

applying the second clear coating composition thereon to form a second clear coating; and

heating (or baking) the second clear coating to form a cured second clear coating film.

This method is referred to as a three coatings and two bakings (3C2B) coating process.

Specifically, a base coating composition including a solid color coating composition, a metallic color coating composition or a pearl tone color coating composition can be directly applied on an article. The article to be coated may be a material of a metal or a plastic for a vehicle body. An under coating composition such as a cationic electrodeposition coating composition can be applied on the article, and if necessary, an intermediate coating composition can be applied thereon. These coatings are cured before the application of the base coating composition. The application of the base coating composition can be carried out by a means of an air spraying or an electrostatic coating such that the resulting cured coating film has a thickness within a range of from 10 to 30 μm. If necessary, there may be an interval at room temperature for several minutes before the application of the first clear coating composition.

The first clear coating composition may be a coating composition having no coloring pigments or a colored coating composition to provide a colored transparent coating film (in a solid color, a metallic color or a pearl tone color). The underlying base coating film of the base coating composition can be visually observed through the colored transparent coating film. The first clear coating composition can be applied on an uncured base coating of a base coating composition by a means of an air spraying or an electrostatic coating such that the resulting cured coating film has a thickness within a range of from 10 to 50 μm. If necessary, there may be an interval at room temperature for several minutes. Both of the base coating and the first clear coating can be heated and cured, by crosslinking, at 100 to 180° C., and preferably 120 to 160° C., for 10 to 40 minutes.

Subsequently, the second clear coating composition can be applied on the cured first clear coating film by a means of an air spraying or an electrostatic coating such that the resulting cured coating film has a thickness within a range of from 20 to 200 μm. The second clear coating can be heated, and cured, by crosslinking, at 100 to 180° C., and preferably 120 to 160° C., for 10 to 40 minutes. Finally, a multilayered top coating film can be prepared.

### EXAMPLES

The present invention is further described in detail in accordance with the following Examples in comparison with the Comparison Examples. In the Examples and the Comparison Examples, “part(s)” and “%” are based on weight unless otherwise specified. Those skilled in the art will appreciate that the present invention is not limited to these Examples.

### Examples 1 to 22 and Comparison Examples 1 to 18

### (1) Preparation of First Clear Coating Composition

### Preparation Example 1

### Synthesis of Acryl Resin (a-1)

70.0 g of Xylene and 30.0 g of n-butanol were charged into a separable flask equipped with a reflux condenser, a dropping funnel, a thermometer and a stirring blade. The mixture was heated to 120° C. under a nitrogen atmosphere. A monomer mixed solution of 35.0 parts of styrene, 14.5 parts of n-butyl acrylate, 38.6 parts of 4-hydroxybutyl acrylate, 10.0 parts of lauryl methacrylate, 1.9 parts of acrylic acid, 7.0 g of Kaya ester-O (commercially available form Kayaku Akzo Corporation, as a radical polymerization initiator) and 10.0 g of xylene was added dropwise through the dropping funnel at a constant rate over 3 hours to the mixture. After the addition, the mixture was kept under the nitrogen atmosphere, with stirring, at the same temperature for 30 minutes. Subsequently, a mixed solution of 10.0 g of xylene and 1.0 g of Kaya ester-O was added dropwise through the dropping funnel at a constant rate over 30 minutes to the mixture. Then, the mixture was kept under the nitrogen atmosphere, with stirring, at the same temperature for 2 hours to give an acryl resin having a hydroxyl value of 150 mgKOH/g, an acid value of 15 mgKOH/g and a number average molecular weight of 3500.

### Preparation Examples 2 to 13

### Synthesis of Acryl Resins (a-2) to (a-13)

Acryl resins (a-2) to (a-13) were prepared according to the Preparation Example 1 with the proviso that the monomer mixed solutions were used as listed in the following Tables 1 and 2.

### Preparation Example 14

### Synthesis of Acryl Resin (b-1)

70.0 g of Solvesso 100 (S-100) and 30.0 g of butyl acetate were charged into a separable flask equipped with a reflux condenser, a dropping funnel, a thermometer and a stirring blade. The mixture was heated to 130° C. under a nitrogen atmosphere. A monomer mixed solution of 35.0 parts of styrene, 1.3 parts of n-butyl acrylate, 25.7 parts of 4-hydroxybutyl acrylate, 38.0 parts of glycidyl methacrylate, 8.0 g of Kaya ester-O and 10.0 g of S-100 was added dropwise through the dropping funnel at a constant rate over 3 hours to the mixture. After the addition, the mixture was kept under the nitrogen atmosphere, with stirring, at the same temperature for 30 minutes. Subsequently, a mixed solution of 10.0 g of S-100 and 1.0 g of Kaya ester-O was added dropwise through the dropping funnel at a constant rate over 30 minutes to the mixture. Then, the mixture was kept under the nitrogen atmosphere, with stirring, at the same temperature for 2 hours to give an acryl resin having a hydroxyl value of 100 mgKOH/g, an epoxy equivalent of 374 g/eq and a number average molecular weight of 2500.

### Preparation Examples 13 to 21

### Synthesis of Acryl Resins (b-2) to (b-8)

Acryl resins (b-2) to (b-8) were prepared according to the Preparation Example 13 with the proviso that the monomer mixed solutions were used as listed in the following Table 3. Hydroxyl values, acid values and number average molecular weights of the prepared acryl resins are also listed in the following Table 3.

TABLE 1

| | | Preparation Example | | | | | |
|---|---|---|---|---|---|---|---|
| | | 1 | 2 | 3 | 4 | 5 | 6 |
| Acryl resin No. | | a-1 | a-2 | a-3 | a-4 | a-5 | a-6 |
| Formulation | Styrene | 35.0 | 35.0 | 35.0 | 35.0 | 35.0 | 35.0 |
| of monomer | n-Butyl | 14.5 | 24.5 | 22.0 | 11.5 | 21.5 | 18.3 |
| mixed | acrylate | | | | | | |
| solution | 4-Hydroxybutyl | 38.6 | 38.6 | | 38.6 | 38.6 | 19.3 |
| | acrylate | | | | | | |
| | Placcel | | | | | | |
| | FM-1 | | | | | | |
| | BLEMMER | | | | | | |
| | AP-150 | | | | | | |
| | 2-hydroxyethyl | | | 31.1 | | | 15.5 |
| | acrylate | | | | | | |
| | Lauryl | 10.0 | | 10.0 | 10.0 | 3.0 | 10.0 |
| | methacrylate | | | | | | |
| | Dodecyl | | | | 3.0 | | |
| | methacrylate | | | | | | |
| | Acrylic | 1.9 | 1.9 | 1.9 | 1.9 | 1.9 | 1.9 |
| | acid | | | | | | |

| | | | | | | |
|---|---|---|---|---|---|---|
| Hydroxyl value | 150 | 150 | 150 | 150 | 150 | 150 |
| (mgKOH/g) | | | | | | |
| Acid value | 15 | 15 | 15 | 15 | 15 | 15 |
| (mgKOH/g) | | | | | | |
| Number average | 3500 | 3500 | 3500 | 3000 | 3500 | 3000 |
| molecular weight | | | | | | |
| (by GPC) | | | | | | |

Placcel FM-1: a monomer which is an addition product of 1 mol of ε-caprolactone to 1 mol of hydroxyethyl methacrylate, which is produced by DAICEL CHEMICAL INDUSTRIES, LTD.

BLEMMER AP-150: a monoester of acrylic acid with polypropylene glycol, which is produced by NOF CORPORATION

TABLE 2

| | | Preparation Example | | | | | | |
|---|---|---|---|---|---|---|---|---|
| | | 7 | 8 | 9 | 10 | 11 | 12 | 13 |
| Acryl resin No. | | a-7 | a-8 | a-9 | a-10 | a-11 | a-12 | a-13 |
| Formulation | Styrene | 35.0 | 35.0 | 35.0 | 35.0 | 35.0 | 35.0 | 35.0 |
| of monomer | n-Butyl | 1.2 | 24.9 | 27.4 | 9.5 | 11.3 | 1.02 | 0.9 |
| mixed | acrylate | | | | | | | |
| solution | 4-Hydroxybutyl | 19.3 | 28.2 | 25.7 | 43.6 | 38.6 | 38.6 | 19.3 |
| | acrylate | | | | | | | |
| | Placcel | 2.6 | | | | | | |
| | FM-1 | | | | | | | |
| | BLEMMER | | | | | | | 32.9 |
| | AP-150 | | | | | | | |
| | 2-hydroxyethyl | | | | | | | |
| | acrylate | | | | | | | |
| | Lauryl | 10.0 | 10.0 | 10.0 | 10.0 | 10.0 | 25.0 | 10.0 |
| | methacrylate | | | | | | | |
| | Decyl | | | | | | | |
| | methacrylate | | | | | | | |
| | Acrylic | 1.9 | 1.9 | 1.9 | 1.9 | 5.1 | 0.38 | 0.38 |
| | acid | | | | | | | |

| | | | | | | | |
|---|---|---|---|---|---|---|---|
| Hydroxyl value | 150 | 110 | 100 | 170 | 150 | 150 | 150 |
| (mgKOH/g) | | | | | | | |
| Acid value | 15 | 15 | 15 | 15 | 40 | 5 | 5 |
| (mgKOH/g) | | | | | | | |
| Number average | 2800 | 10000 | 5500 | 3500 | 3500 | 3500 | 3500 |
| molecular weight | | | | | | | |
| (by GPC) | | | | | | | |

TABLE 3

| | | Preparation Example | | | | | | | |
|---|---|---|---|---|---|---|---|---|---|
| | | 14 | 15 | 16 | 17 | 18 | 19 | 20 | 21 |
| Acryl resin No. | | b-1 | b-2 | b-3 | b-4 | b-5 | b-6 | b-7 | b-8 |
| Formulation | Styrene | 35.0 | 35.0 | 35.0 | 15.0 | 35.0 | 35.0 | 3.0 | 15.0 |
| of monomer | n-Butyl | 1.3 | 39.3 | 27.0 | 2.5 | 19.0 | 16.7 | 0.3 | 3.4 |
| mixed | acrylate | | | | | | | | |
| solution | 4-Hydroxybutyl | 25.7 | 25.7 | | 20.1 | 25.7 | 26.9 | 25.7 | 43.6 |
| | acrylate | | | | (80) | | (80) | | |
| | Placcel | | | | | | 6.7 | | |
| | FM-1 | | | | | | (20) | | |
| | 2-hydroxyethyl | | | | 5.0 | | | | |
| | acrylate | | | | (20) | | | | |
| | glycidyl | 38.0 | | 38.0 | 56.8 | 20.3 | 38.0 | 71.0 | 38.0 |
| | methacrylate | | | | | | | | |

| | | | | | | | | |
|---|---|---|---|---|---|---|---|---|
| Hydroxyl value | 100 | 100 | 0 | 100 | 100 | 120 | 100 | 170 |
| (mgKOH/g) | | | | | | | | |
| Epoxy equivalent | 374 | 0 | 374 | 250 | 700 | 374 | 200 | 374 |
| (g/eq) | | | | | | | | |
| Number average | 2500 | 2500 | 2500 | 2100 | 10000 | 2500 | 2500 | 2100 |
| molecular weight | | | | | | | | |
| (by GPC) | | | | | | | | |

Preparation of First Clear Coating Composition

An acryl resin (a), an acryl resin (b) and a melamine resin according to a formulation in the following Table 4 were weighted in a stainless steel beaker. Subsequently, a thinner of Solvesso 100 and ethyl acetate (Solvesso 100/etyl acetate=1/1) (in a weight basis) were added to the mixture. The mixture was stirred in a disper to give a first clear coating composition. Subsequently, viscosity of the first clear coating composition was adjusted with the thinner such that the viscosity was that in a Ford cup No. 4 (20° C.).

SP value of a melamine resin (“U-VAN-20N-60” produced by Mitsui Toatsu Chemicals, Inc.) was measured according to the above-described procedures wherein the measuring temperature was 20° C. The detail conditions are as follows.

Sample: 0.5 g of a melamine resin is weighed in a 100 ml beaker, 10 ml of acetone is added to the beaker with a whole pipette, and then the resin is dissolved in acetone by a magnetic stirrer.

SP value of acetone (δg): 9.77

SP value of hexane (φpl): 7.24

SP value of deionized water (δph): 23.50

Turbidimetric titration: Poor solvent (hexane or deionized water) is added dropwise to the sample with a 50 ml burette, and then at a point at which turbidity is generated, the titration amount is recorded.

φpl: volume proportion of hexane

φph: volume proportion of deionized water

Titration amount of hexane: 58.21 ml

Titration amount of deionized water: 1.74 ml

SP value of the melamine resin can be determined by the above Equations I and II with the above values.

φpl=(58.21)/(58.21+10)≈0.8534

φph=(1.74)/(1.74+10)≈0.1482

δml=φpl×δpl+(1−φpl)×δg=(0.8534)(7.24)+(1−0.8534)(9.77)≈7.6109

δmh=φph×δph+(1−φph)×δg=(0.1482)(23.5)+(1−0.1482)(9.77)≈11.8048

The SP value of the resin is represented below according to the Equation III

δpoly=(δml+δmh)/2=(7.6109+11.8048)/2≈9.7

SP values of the melamine resins used in the Examples and Comparison Examples were determined in similar procedures. Results are shown in the following Tables 4 to 8.

The coating compositions of the Examples and Comparison Examples ware prepared according to the formulations in the following Tables 4 to 8 in similar procedures.

(2) Preparation of Second Clear Coating Composition

As a second clear coating composition, the following coating composition was used:

“MACFLOW O-1820 CLEAR” (a clear coating composition under a product name of “MACFLOW O-1820 CLEAR” produced by NIPPON PAINT Co., Ltd.; which comprises (I) a copolymer of a radical polymerizable monomer having an acid anhydride group and other copolymerizable monomer, wherein the acid anhydride group is half esterified; (II) a copolymer having a hydroxyl group and an epoxy group; and (III) a polyester resin containing a carboxyl group and a hydroxyl group); or a two-solution component polyurethane coating composition in a polyisocyanate-acryl resin system (sovent-type) (under a product name of “R290S CLEAR” produced by Nippon Bee Chemical Co., Ltd.).

(3) Preparation of Coated Panel

A steel plate treated with zinc phosphate was subjected to a cationic electrodeposition coating with a cationic electrodeposition coating composition of “POWERTOP U-80”, produced by NIPPON PAINT Co., Ltd. The coated plate was baked and dried. An intermediate coating composition “ORGA P-2” (produced by NIPPON PAINT Co., Ltd.) was applied on the cured electrodeposition coating film, and then baked and dried. On thus prepared specimen panel, a base coating composition “AQUAREX AR-2000 silver metallic” (produced by NIPPON PAINT Co., Ltd.) was applied. Subsequently, a first clear coating composition was applied thereon by a wet-on-wet procedure. The panel was baked and dried at 140° C. for 30 minutes. Subsequently, a second clear coating composition was applied on the first clear coating film. The panel was baked and dried at 140° C. for 30 minutes to give a multi layered coating film.

TABLE 4

| | | | | Example | | | | | | | |
|---|---|---|---|---|---|---|---|---|---|---|---|
| | | | | 1 | 2 | 3 | 4 | 5 | 6 | 7 | 8 |
| 1st | Acryl | Acryl resin | | a-1 | a-1 | a-1 | a-1 | a-1 | a-1 | a-1 | a-4 |
| Clear | resin | (a) | | | | | | | | | |
| | | Content | | 60 | 60 | 60 | 60 | 60 | 52.5 | 52.5 | 60 |
| | | Acryl resin | | b-1 | b-1 | b-1 | b-1 | b-1 | b-1 | b-1 | b-1 |
| | | (b) | | | | | | | | | |
| | | Content | | 20 | 20 | 20 | 20 | 20 | 17.5 | 17.5 | 20 |
| | Melamine | Product | SP | 10 | 10 | 10 | 5 | — | 15 | 7.5 | 10 |
| | resin | Name | Value | | | | | | | | |
| | | U-VAN- | 9.7 | | | | | | | | |
| | | 20N-60 | | | | | | | | | |
| | | U-VAN- | 9.8 | 10 | — | — | 15 | 5 | 15 | 22.5 | 10 |
| | | 225* | | | | | | | | | |
| | | Mycoat | 10.8 | — | 10 | — | — | 15 | — | — | — |
| | | 508* | | | | | | | | | |
| | | U-VAN- | 9.5 | — | — | 10 | — | — | — | — | — |
| | | 125* | | | | | | | | | |
| | | Cymel | 12.2 | — | — | — | — | — | — | — | — |
| | | 327* | | | | | | | | | |

| 2nd Clear | | MACFLOW O-1820 | | | | | | | |
|---|---|---|---|---|---|---|---|---|---|
| Properties | F-F property | 4 | 4 | 4 | 4 | 4 | 4 | 4 | 4 |
| | 1st Adhesion | 5 | 5 | 5 | 5 | 5 | 5 | 5 | 5 |
| | 2nd Adhesion | 5 | 5 | 4 | 5 | 4 | 5 | 5 | 5 |
| | (after water | | | | | | | | |
| | resistance test) | | | | | | | | |
| | Adhesion after | 5 | 5 | 5 | 5 | 5 | 5 | 5 | 5 |
| | Thermal cycle test | | | | | | | | |

*Imino group-containing melamine resin

TABLE 5

| | | | | Example | | | | | | |
|---|---|---|---|---|---|---|---|---|---|---|
| | | | | 9 | 10 | 11 | 12 | 13 | 14 | 15 |
| 1st | Acryl | Acryl resin | | a-6 | a-7 | a-8 | a-13 | a-1 | a-1 | a-1 |
| Clear | resin | (a) | | | | | | | | |
| | | Content | | 60 | 60 | 60 | 60 | 60 | 60 | 60 |
| | | Acryl resin | | b-1 | b-1 | b-1 | b-1 | b-4 | b-5 | b-6 |
| | | (b) | | | | | | | | |
| | | Content | | 20 | 20 | 20 | 20 | 20 | 20 | 20 |
| | Melamine | Product | SP | 10 | 10 | 10 | 10 | 10 | 10 | 10 |
| | resin | Name | Value | | | | | | | |
| | | U-VAN- | 9.7 | | | | | | | |
| | | 20N-60O | | | | | | | | |
| | | U-VAN- | 9.8 | 10 | 10 | 10 | 10 | 10 | 10 | 10 |
| | | 225* | | | | | | | | |
| | | Mycoat | 10.8 | — | — | — | — | — | — | — |
| | | 508* | | | | | | | | |
| | | U-VAN- | 9.5 | — | — | — | — | — | — | — |
| | | 125* | | | | | | | | |
| | | Cymel | 12.2 | — | — | — | — | — | — | — |
| | | 327* | | | | | | | | |

| 2nd Clear | | MACFLOW O-1820 | | | | | | |
|---|---|---|---|---|---|---|---|---|
| Properties | F-F property | 4 | 4 | 4 | 4 | 4 | 4 | 4 |
| | 1st Adhesion | 5 | 5 | 5 | 5 | 5 | 5 | 5 |
| | 2nd Adhesion | 5 | 5 | 4 | 5 | 5 | 5 | 5 |
| | (after water | | | | | | | |
| | resistance test) | | | | | | | |
| | Adhesion after | 4 | 5 | 5 | 4 | 4 | 4 | 5 |
| | Thermal cycle test | | | | | | | |

*Imino group-containing melamine resin

TABLE 6

| | | | | Comparison Example | | | | | | | |
|---|---|---|---|---|---|---|---|---|---|---|---|
| | | | | 1 | 2 | 3 | 4 | 5 | 6 | 7 | 8 |
| 1st | Acryl | Acryl resin | | a-2 | a-1 | a-1 | a-1 | a-2 | a-2 | a-1 | a-5 |
| Clear | resin | (a) | | | | | | | | | |
| | | Content | | 60 | 60 | 60 | 60 | 52.5 | 60 | 60 | 60 |
| | | Acryl resin | | b-1 | b-2 | b-1 | b-3 | b-1 | b-2 | b-1 | b-1 |
| | | (b) | | | | | | | | | |
| | | Content | | 20 | 20 | 20 | 20 | 17.5 | 20 | 20 | 20 |
| | Melamine | Product | SP | 10 | 10 | 20 | 10 | 15 | 10 | 10 | 10 |
| | resin | Name | Value | | | | | | | | |
| | | U-VAN- | 9.7 | | | | | | | | |
| | | 20N-60 | | | | | | | | | |
| | | U-VAN- | 9.8 | 10 | 10 | — | 10 | 15 | 10 | — | 10 |
| | | 225* | | | | | | | | | |
| | | Mycoat | 10.8 | — | — | — | — | — | — | — | — |
| | | 508* | | | | | | | | | |
| | | U-VAN- | 9.5 | — | — | — | — | — | — | — | — |
| | | 125* | | | | | | | | | |
| | | Cymel | 12.2 | — | — | — | — | — | — | 10 | — |
| | | 327* | | | | | | | | | |

| 2nd Clear | | MACFLOW O-1820 | | | | | | | |
|---|---|---|---|---|---|---|---|---|---|
| Properties | F-F property | 1 | 4 | 4 | 4 | 1 | 3 | 3 | 3 |
| | 1st Adhesion | 5 | 1 | 1 | 1 | 5 | 5 | 1 | 5 |
| | 2nd Adhesion | 5 | 1 | 1 | 1 | 5 | 1 | 1 | 5 |
| | (after water | | | | | | | | |
| | resistance test) | | | | | | | | |
| | Adhesion after | 1 | 1 | 1 | 1 | 1 | 1 | 1 | 1 |
| | Thermal cycle test | | | | | | | | |

*Imino group-containing melamine resin

TABLE 7

| | | | | Comparison Example | | | | | | | |
|---|---|---|---|---|---|---|---|---|---|---|---|
| | | | | 9 | 10 | 11 | 12 | 13 | 14 | 15 | 16 |
| 1st | Acryl | Acryl resin | | a-1 | a-9 | a-10 | a-11 | a-12 | a-1 | a-1 | a-3 |
| Clear | resin | (a) | | | | | | | | | |
| | | Content | | 60 | 60 | 60 | 60 | 60 | 60 | 60 | 60 |
| | | Acryl resin | | b-1 | b-1 | b-1 | b-1 | b-1 | b-7 | b-8 | b-1 |
| | | (b) | | | | | | | | | |
| | | Content | | 20 | 20 | 20 | 20 | 20 | 20 | 20 | 20 |
| | Melamine | Product | SP | 15 | 10 | 10 | 10 | 10 | 10 | 10 | 10 |
| | resin | Name | Value | | | | | | | | |
| | | U-VAN- | 9.7 | | | | | | | | |
| | | 20N-60 | | | | | | | | | |
| | | U-VAN- | 9.8 | 5 | 10 | 10 | 10 | 10 | 10 | 10 | 10 |
| | | 225* | | | | | | | | | |
| | | Mycoat | 10.8 | — | — | — | — | — | — | — | — |
| | | 508* | | | | | | | | | |
| | | U-VAN- | 9.5 | — | — | — | — | — | — | — | — |
| | | 125* | | | | | | | | | |
| | | Cymel | 12.2 | — | — | — | — | — | — | — | — |
| | | 327* | | | | | | | | | |

| 2nd Clear | | MACFLOW O-1820 | | | | | | | |
|---|---|---|---|---|---|---|---|---|---|
| Properties | F-F property | 4 | 4 | 3 | 3 | 4 | 3 | 3 | 4 |
| | 1st Adhesion | 1 | 5 | 5 | 5 | 1 | 5 | 5 | 1 |
| | 2nd Adhesion | 1 | 1 | 1 | 1 | 1 | 1 | 1 | 1 |
| | (after water | | | | | | | | |
| | resistance test) | | | | | | | | |
| | Adhesion after | 1 | 5 | 5 | 5 | 1 | 5 | 5 | 1 |
| | Thermal cycle test | | | | | | | | |

*Imino group-containing melamine resin

TABLE 8

| | | | | | | | | | | | Comp. | |
|---|---|---|---|---|---|---|---|---|---|---|---|---|
| | | | | Example | | | | | | | Example | |
| | | | | 16 | 17 | 18 | 19 | 20 | 21 | 22 | 17 | 18 |
| 1st | Acryl | Acryl resin | | a-1 | a-1 | a-1 | a-1 | a-1 | a-1 | a-1 | a-2 | a-1 |
| Clear | resin | (a) | | | | | | | | | | |
| | | Content | | 60 | 60 | 60 | 60 | 60 | 52.5 | 52.5 | 60 | 60 |
| | | Acryl resin | | b-1 | b-1 | b-1 | b-1 | b-1 | b-1 | b-1 | b-1 | b-2 |
| | | (b) | | | | | | | | | | |
| | | Content | | 20 | 20 | 20 | 20 | 20 | 17.5 | 17.5 | 20 | 20 |
| | Melamine | Product | SP | 10 | 10 | 10 | 5 | 5 | 15 | 7.5 | 10 | 10 |
| | resin | Name | Value | | | | | | | | | |
| | | U-VAN- | 9.7 | | | | | | | | | |
| | | 20N-60 | | | | | | | | | | |
| | | U-VAN- | 9.8 | 10 | — | — | 15 | — | 15 | — | 10 | 10 |
| | | 225* | | | | | | | | | | |
| | | Mycoat | 10.8 | — | 10 | — | — | 15 | — | — | — | — |
| | | 508* | | | | | | | | | | |
| | | U-VAN-125* | 9.5 | — | — | 10 | — | — | — | 22.5 | — | — |
| | | Cymel | 12.2 | — | — | — | — | — | — | — | — | — |
| | | 327* | | | | | | | | | | |

| 2nd Clear | | R290S CLEAR | | | | | | | | |
|---|---|---|---|---|---|---|---|---|---|---|
| Properties | F-F property | 4 | 4 | 4 | 4 | 4 | 4 | 4 | 1 | 4 |
| | 1st Adhesion | 5 | 5 | 5 | 5 | 5 | 5 | 5 | 5 | 1 |
| | 2nd Adhesion | 5 | 5 | 4 | 5 | 5 | 5 | 4 | 5 | 1 |
| | (after water | | | | | | | | | |
| | resistance test) | | | | | | | | | |
| | Adhesion after | 5 | 4 | 5 | 5 | 5 | 5 | 4 | 1 | 1 |
| | Thermal cycle test | | | | | | | | | |

*Imino group-containing melamine resin

Thus prepared multi layered coating film was evaluated on flip-flop property, adhesion between the first clear coating composition and the second clear coating composition (i.e., primary adhesion or 1st adhesion), and adhesion after water resistance test (i.e., secondary adhesion or 2nd adhesion). Results are shown in the above Tables 4 to 8.

Flip-Flop Property

Flip-flop property was evaluated by a ratio of L value at 75° of a light-receiving angle (as a shade) to L value at 25° of a light-receiving angle (as a highlight) [L (75°)/L (25°)], both of which were measured in a spectrophotometer under a product name of “CM-512M3” produced by MINOLTA. The evaluated coating film had a light silver color [L value at 25° of a light-receiving angle (as a front)=about 105). Evaluation bases are as follows.
1 [Bad (×)]: L (75°)/L (25°) is less than 2.0.
2 [No good (Δ)]: L (75°)/L (25°) is between 2.0 and 2.2 (including 2.0 and excluding 2.2).
3 [Good (◯)]: L (75°)/L (25°) is between 2.2 and 2.5 (including 2.2 and excluding 2.5).
4 [Excellent (⊚)]: L (75°)/L (25°) is no less than 2.5.
   Results are shown in the above Tables 3 and 4.

Adhesion (Primary Adhesion)

The multi layered coating film formed on the panel, i.e., the specimen panel was scaled with a blade of a cutter knife (under a product name of NT CUTTER, S type or A type, or a correspondent thereof), in 2 mm intervals, with keeping the blade at an angle of about 30° to the panel to give a checked pattern having 100 squares, so that the blade was reached to the base steel plate. An adhesive tape (produced by NICHIBAN CO., LTD.) was uniformly attached all over the coating film so as to remove any air blisters. The adhesive tape was peeled from one side at once with keeping an angle of 30° of the peeled adhesive tape to the panel. The adhesion of the coating film to the panel was visually evaluated based on an evaluation basis: a ratio of [Number of the still adhered coating squares]/[Total number of the squares (100)]. Results are shown in the above Tables.
5 [Excellent (◯)]: No square peelings
4 [Good (◯Δ)]: Slight peeling on square edge(s)
3 [Not bad (Δ)]: Partial peeling on square edge(s)
2 [Not good (ΔX)]. Large peeling on square edge(s)
1 [Bad (X)]: One or more square peelings

Adhesion After Water Resistance Test (Secondary Adhesion)

The panel having the multi layered coating film, i.e., the specimen panel was immersed into water at 40° C. and maintained for 20 days. The panel was taken out and the multi layered coating film thereon was immediately scaled with a blade of a cutter knife (under a product name of NT CUTTER, S type or A type, or a correspondent thereof), in 2 mm intervals, with keeping the blade at an angle of about 30° to the panel to give a checked pattern having 100 squares, so that the blade was reached to the base steel plate. An adhesive tape (produced by NICHIBAN CO., LTD.) was uniformly attached all over the coating film so as to remove any air blisters. The adhesive tape was peeled from one side at once with keeping an angle of 30° of the peeled adhesive tape to the panel. The evaluation is according to that of the primary adhesion.

### Thermal Cycle Test

The specimen panel having the multi layered coating film was subjected to a thermal cycle test which comprises three steps (i), (ii) and (iii):

(i) a step of exposing the panel to a light from a xenon lamp for 24 hours;
(ii) a step of decreasing the temperature of the coating film to −20° C. over 2 hours and maintaining the temperature (−20° C.) for 5 hours;
(iii) a step of increasing the temperature of the coating film to 60° C. over 2 hours and maintaining the temperature (60° C.) for 5 hours.
The thermal cycle test (steps (i), (ii) and (iii)) was repeated three times. The multi layered coating film on the specimen panel was scaled with a blade of a cutter knife (commercially available under a product name of NT CUTTER, S type or A type, or a correspondent thereof), in 2 mm intervals, with keeping the blade at an angle of about 30° to the panel to give a checked pattern having 100 squares, so that the blade was reached to the base steel plate. An adhesive tape (produced by NICHIBAN Co., LTD.) was uniformly attached all over the coating film so as to remove any air blisters. The adhesive tape was peeled from one side at once with keeping an angle of 30° of the peeled adhesive tape to the panel. The adhesion of the coating film to the panel was visually evaluated based on an evaluation basis: a ratio of [Number of the still adhered coating squares]/[Total number of the squares (=100)]. Results are shown in the above Tables.
5 [Excellent (◯)]: No square peelings
4 [Good (◯Δ)]: Slight peeling on square edge(s)
3 [Not bad (Δ)]: Partial peeling on square edge(s)
2 [Not good (ΔX)]: Large peeling on square edge(s)
1 [Bad (X)]: One or more square peelings

From these results, it was found that the present invention could provide a multi layered coating film having an excellent flip-flop property (i.e., F-F property), which was superior in all of the adhesion between the first clear coating film and the second clear coating film (i.e., primary adhesion), the adhesion after the water resistance test (i.e., secondary adhesion) and the adhesion after the thermal cycle test to those of the conventional coating film.

The detailed analysis results are as follows. The Comparison Example 1 employs the acryl resin (a-2), as an acryl rein (a), which does not encompassed in the acryl monomer (1) having an alkyl ester group having at least 8 carbon atoms. Therefore, the F-F property and the adhesion after the thermal cycle test are inferior.

The Comparison Example 2 employs the acryl resin (b-2) having no epoxy equivalent as an acryl resin (b). Therefore, the primary adhesion and the secondary adhesion are inferior.

The Comparison Example 3 employs the melamine resin without any imino group-containing melamine resin. Therefore, the primary adhesion and the secondary adhesion are inferior.

The Comparison Example 4 employs the acryl resin (b-3) having no hydroxyl value. Therefore, the primary adhesion and the secondary adhesion are inferior.

The Comparison Example 5 is similar to the Comparison Example 1 wherein the contents of the acryl resins and contents of the melamine resins are varied. The results are similar to the Comparison Example 1, i.e., the F-F property and the adhesion after the thermal cycle test are inferior.

The Comparison Example 6 employs the acryl resin (a-2) as an acryl resin (a) and the acryl resin (b-2) as an acryl resin (b), both of which are excluded from the scope of the present invention. Therefore, the secondary adhesion and the adhesion after the thermal cycle test are inferior.

The Comparison Example 7 employs the imino group-containing melamine resin having a higher SP value of 12.2 than that of the present invention. Therefore, the primary adhesion and the secondary adhesion are inferior.

The Comparison Example 8 employs the acryl monomer (1) having an alkyl ester group having at least 8 carbon atoms, which content is small and 3.0% by weight relative to the total monomer weight. Therefore, the F-F property and the adhesion after the thermal cycle test are inferior.

The Comparison Example 9 employs the melamine resin having a small content of 25% by weight of the imino group-containing melamine resin. Therefore, the primary adhesion and the secondary adhesion are inferior.

The Comparison Example 10 employs the acryl resin (a-9) having a smaller hydroxyl value of 100 than that in the present invention. Therefore, the F-F property is excellent, but the secondary adhesion is inferior.

In contrast with the Comparison Example 10, the Comparison Example 11 employs the acryl resin (a-10) having a higher hydroxyl value of 170 than that in the present invention. Therefore, the secondary adhesion is inferior.

The Comparison Example 12 employs the acryl resin (a-11) having a higher acid value than that in the present invention. Therefore, the primary adhesion and the secondary adhesion are deteriorated.

The Comparison Example 13 employs the acryl monomer (a) having an alkyl ester group having at least 8 carbon atoms, the content of which is 25% by weight relative to the total monomer weight (which is more than 20% by weight). Therefore, the F-F property is excellent, but the primary adhesion and the secondary adhesion are deteriorated.

The Comparison Example 14 employs the acryl resin (b-7) having a smaller epoxy equivalent of 200, as an acryl resin (b), than that in the present invention. Therefore, the secondary adhesion is deteriorated.

The Comparison Example 15 employs the acryl resin (b-8) having a higher hydroxyl value of 170, as an acryl resin (b), than that in the present invention. Therefore, the secondary adhesion is deteriorated.

The Comparison Example 16 employs the acryl resin (a-3) without the acryl monomer (2) having a hydroxyl group wherein at least 4 carbon atoms are placed between the hydroxyl group and the acryl group therein. Therefore, the primary adhesion and the secondary adhesion are inferior.

The Comparison Examples 17 and Comparison Example 18 according to the Comparison Examples 1 and 2, wherein the second clear coating composition is altered respectively, provides the similar results those resulted from the Comparison Examples 1 and 2.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including”, and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those skilled in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for producing a top coating film comprising a base coating film, a first clear coating film and a second clear coating film, which includes steps of:
applying a base coating composition on an article to form a base coating;
applying a first clear coating composition on the base coating to form a first clear coating;
curing the base coating and the first clear coating at once to form a base coating film and a first clear coating film;
applying a second clear coating composition thereon to form a second clear coating; and
curing the second clear coating to form a second clear coating film,
wherein the first clear coating composition comprises
(a) an acryl resin having a hydroxyl value of 110 to 160 mgKOH/g and an acid value of 5 to 35 mgKOH/g, which is obtainable by a polymerization of (1) an acryl monomer having an alkyl ester group having at least 8 carbon atoms, (2) an acryl monomer having a hydroxyl group wherein at least 4 carbon atoms are placed between the hydroxyl group and the acryl group therein, (3) an acryl monomer having a carboxyl group, and (4) other acryl monomer, wherein content of the acryl monomer (1) having an alkyl ester group having at least 8 carbon atoms is 5 to 20% by weight relative to total monomer weight;
(b) an acryl resin having a hydroxyl value of 10 to 150 mgKOH/g and an epoxy equivalent of 230 to 800 g/eq, which is obtainable by a polymerization of (5) an acryl monomer having a hydroxyl group, (6) an acryl monomer having an epoxy group, and (7) other acryl monomer; and
(c) a curing agent of a melamine resin, which has a solubility parameter (SP value) within a range of from 9.5 to 11.0, and which comprises no less than 50% by weight of an imino group-containing melamine resin, and
wherein the second clear coating composition is a clear coating composition comprising a polyepoxide and a polyacid, or an urethane clear coating composition comprising a hydroxyl group-containing resin and a polyisocyanate curing agent.

2. A first clear coating composition comprising
(a) an acryl resin having a hydroxyl value of 110 to 160 mgKOH/g and an acid value of 5 to 35 mgKOH/g, which is obtainable by a polymerization of (1) an acryl monomer having an alkyl ester group having at least 8 carbon atoms, (2) an acryl monomer having a hydroxyl group wherein at least 4 carbon atoms are placed between the hydroxyl group and the acryl group therein, (3) an acryl monomer having a carboxyl group, and (4) other acryl monomer, wherein content of the acryl monomer (1) having an alkyl ester group having at least 8 carbon atoms is 5 to 20% by weight relative to total monomer weight;
(b) an acryl resin having a hydroxyl value of 10 to 150 mgKOH/g and an epoxy equivalent of 230 to 800 g/eq, which is obtainable by a polymerization of (5) an acryl monomer having a hydroxyl group, (6) an acryl monomer having an epoxy group, and (7) other acryl monomer; and
(c) a curing agent of a melamine resin, which has a solubility parameter (SP value) within a range of from 9.5 to 11.0, and which comprises no less than 50% by weight of an imino group-containing melamine resin.

3. Use of the first clear coating composition according to claim 2 in a method for producing a top coating film comprising a base coating film, a first clear coating film and a second clear coating film, which includes steps of:
applying a base coating composition on an article to form a base coating;
applying a first clear coating composition on the base coating to form a first clear coating;
curing the base coating and the first clear coating at once to form a base coating film and a first clear coating film;
applying a second clear coating composition thereon to form a second clear coating; and
curing the second clear coating to form a second clear coating film.
